(19) United States
(12) Patent Application Publication
(10) Pub. No.: US 2021/0304330 A1
(43) Pub. Date: Sep. 30, 2021

(54) DYNAMICALLY DETERMINING CO-BUYERS FOR A PROPERTY

(71) Applicant: CoHomeNow, Inc., Los Altos, CA (US)

(72) Inventor: William L. Lee, Cupertino, CA (US)

(21) Appl. No.: 17/214,679

(22) Filed: Mar. 26, 2021

Related U.S. Application Data
(60) Provisional application No. 63/000,950, filed on Mar. 27, 2020.

(51) Int. Cl. G06Q 50/16; G06N 20/00; G06F 16/248; G06N 5/04; G06Q 30/06; G06Q 40/02

(52) U.S. Cl. CPC G06Q 50/16; G06N 20/00; G06F 16/248; G06Q 30/0605; G06Q 30/0627; G06Q 40/025; G06N 5/04

(57) ABSTRACT

Apparatuses, methods, systems, and program products are disclosed for dynamically determining co-buyers for a property. An apparatus includes a processor and a memory that stores code executable by the processor to receive financial information associated with a first buyer and a geographic location of interest to the first buyer for purchasing real estate, determine one or more real estate properties for sale within the geographic location, and identify one or more potential co-buyers for a selected real estate property of the one or more real estate properties based on the received financial information for the first buyer and financial information associated with each of the one or more potential co-buyers.

### CROSS-REFERENCES TO RELATED APPLICATIONS

This application claims the benefit of U.S. Provisional Patent Application No. 63/000,950 entitled “DYNAMICALLY DETERMINING CO-BUYERS FOR A PROPERTY” and filed on Mar. 27, 2020, for William L. Lee, which is incorporated herein by reference.

### FIELD

This invention relates to computing systems and more particularly relates to dynamically determining co-buyers for a property.

### BACKGROUND

Real estate properties may be purchased cooperatively among different co-buyers. It can be difficult, however, to identify buyers who may be interested in a co-buying arrangement for real estate at a specific location.

### SUMMARY

Apparatuses, methods, systems, and program products are disclosed for dynamically determining co-buyers for a property. An apparatus, in one embodiment, includes a processor and a memory that stores code executable by the processor to receive financial information associated with a first buyer and a geographic location of interest to the first buyer for purchasing real estate, determine one or more real estate properties for sale within the geographic location, and identify one or more potential co-buyers for a selected real estate property of the one or more real estate properties based on the received financial information for the first buyer and financial information associated with each of the one or more potential co-buyers.

In one embodiment, a method includes receiving, by a processor, financial information associated with a first buyer and a geographic location of interest to the first buyer for purchasing real estate, determining one or more real estate properties for sale within the geographic location, and identifying one or more potential co-buyers for a selected real estate property of the one or more real estate properties based on the received financial information for the first buyer and financial information associated with each of the one or more potential co-buyers.

In certain embodiments, a program product includes a computer readable storage medium and program code. In some embodiments, the program code is configured to be executable by a processor to perform operations including receiving financial information associated with a first buyer and a geographic location of interest to the first buyer for purchasing real estate, determining one or more real estate properties for sale within the geographic location, and identifying one or more potential co-buyers for a selected real estate property of the one or more real estate properties based on the received financial information for the first buyer and financial information associated with each of the one or more potential co-buyers.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for dynamically determining co-buyers for a property;

FIG. 2 is a schematic block diagram illustrating one embodiment of an apparatus for dynamically determining co-buyers for a property;

FIG. 3 is a schematic block diagram illustrating one embodiment of another apparatus for dynamically determining co-buyers for a property;

FIG. 4 is a schematic flow chart diagram illustrating one embodiment of a method for dynamically determining co-buyers for a property; and

FIG. 5 is a schematic flow chart diagram illustrating one embodiment of a method for dynamically determining co-buyers for a property.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

An apparatus, in one embodiment, includes a processor and a memory that stores code executable by the processor to receive financial information associated with a first buyer and a geographic location of interest to the first buyer for purchasing real estate, determine one or more real estate properties for sale within the geographic location, and identify one or more potential co-buyers for a selected real estate property of the one or more real estate properties based on the received financial information for the first buyer and financial information associated with each of the one or more potential co-buyers.

In one embodiment, the code is executable by the processor to identify the one or more potential co-buyers based on match criteria for each of the one or more potential co-buyers that the first buyer provides.

In some embodiments, the code is executable by the processor to present the one or more real estate properties that are for sale within the geographic location in one of a list and a map, receive a selection of a presented real estate property from the first buyer, and present a list of the one or more potential co-buyers for the selected real estate property. In one embodiment, the code is executable by the processor to receive a selection of one of the one or more potential co-buyers for the selected real estate property and facilitate communications between the first buyer and the selected co-buyer.

In one embodiment, the code is executable by the processor to determine one or more financial institutions that can facilitate purchasing the selected real estate property based on the financial information for the first buyer and the financial information for the one or more potential co-buyers.

In one embodiment, the code is executable by the processor to pre-populate one or more fields in an application for financing at a selected one of the determined one or more financial institutions with personal and financial information for the first buyer and a selected one of the one or more potential co-buyers.

In one embodiment, the code is executable by the processor to use machine learning to rank each of the one or more potential co-buyers for the selected real estate property based on the financial information for each of the potential co-buyers and match criteria for the one or more potential co-buyers that the first buyer provides.

In one embodiment, the code is executable by the processor to filter the determined real estate properties that are for sale within the geographic location by a selected potential co-buyer. In one embodiment, the code is executable by the processor to use machine learning to estimate the first buyer's portion of a monthly payment and a total monthly cost of the selected real estate property based on each of the potential co-buyers.

In one embodiment, the code is executable by the processor to visually highlight real estate properties within the geographic location that match different levels of the first buyer's financial information, home criteria, and co-buyer criteria. In one embodiment, the code is executable by the processor to calculate an estimated portion of the down payment for the first buyer for the selected real estate property.

In one embodiment, the determined one or more real estate properties for the geographic location comprises fractional shares of real estate properties that are for sale. In one embodiment, the financial information for the first buyer and the one or more co-buyers comprises a gross monthly income, an amount available for a down payment, a credit score, and a debt level. In one embodiment, the code is executable by the processor to crowdsource real estate preference information from the first buyer and the one or more potential co-buyers to determine real-estate trends.

In one embodiment, a method includes receiving, by a processor, financial information associated with a first buyer and a geographic location of interest to the first buyer for purchasing real estate, determining one or more real estate properties for sale within the geographic location, and identifying one or more potential co-buyers for a selected real estate property of the one or more real estate properties based on the received financial information for the first buyer and financial information associated with each of the one or more potential co-buyers.

In one embodiment, the method includes identifying the one or more potential co-buyers based on match criteria for each of the one or more potential co-buyers that the first buyer provides. In one embodiment, the method includes presenting the one or more real estate properties that are for sale within the geographic location in one of a list and a map, receiving a selection of a presented real estate property from the first buyer, and presenting a list of the one or more potential co-buyers for the selected real estate property.

In one embodiment, the method includes receiving a selection of one of the one or more potential co-buyers for the selected real estate property and facilitating communications between the first buyer and the selected co-buyer. In one embodiment, the method includes determining one or more financial institutions that can facilitate purchasing the selected real estate property based on the financial information for the first buyer and the financial information for the one or more potential co-buyers.

In certain embodiments, a program product includes a computer readable storage medium and program code. In some embodiments, the program code is configured to be executable by a processor to perform operations including receiving financial information associated with a first buyer and a geographic location of interest to the first buyer for purchasing real estate, determining one or more real estate properties for sale within the geographic location, and identifying one or more potential co-buyers for a selected real estate property of the one or more real estate properties based on the received financial information for the first buyer and financial information associated with each of the one or more potential co-buyers.

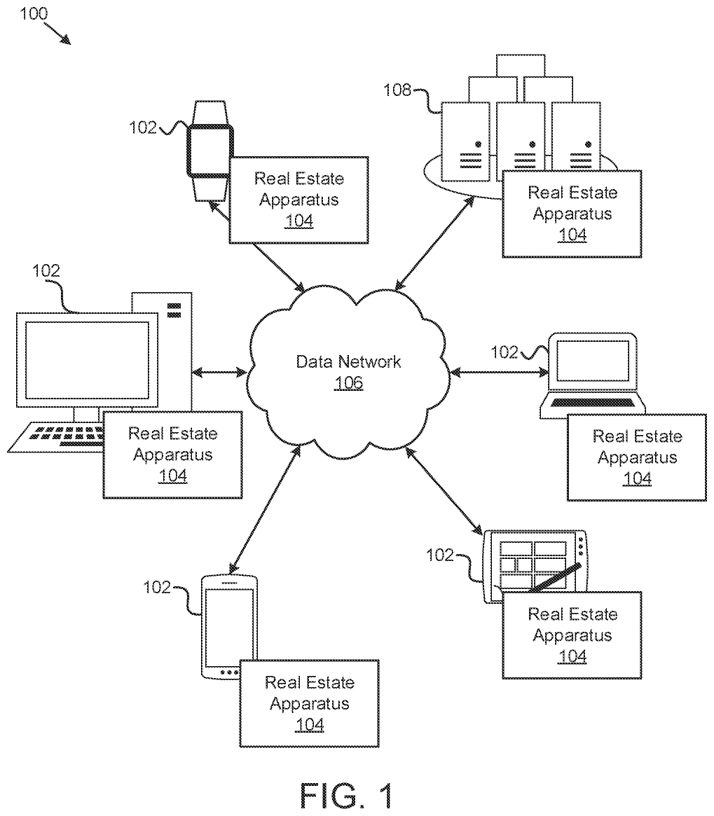

FIG. 1 is a schematic block diagram illustrating one embodiment of a system 100 for dynamically determining co-buyers for a property. In one embodiment, the system 100 includes one or more information handling devices 102, one or more real estate apparatuses 104, one or more data networks 106, and one or more servers 108. In certain embodiments, even though a specific number of information handling devices 102, real estate apparatuses 104, data networks 106, and servers 108 are depicted in FIG. 1, one of skill in the art will recognize, in light of this disclosure, that any number of information handling devices 102, real estate apparatuses 104, data networks 106, and servers 108 may be included in the system 100.

The system 100, in one embodiment, is a platform for matching a buyer with potential co-buyers for purchasing a real estate property such as a home that the buyer or the potential co-buyers would otherwise not be able to purchase in their current financial state. The system 100 efficiently connects a plurality of buyers from various different locations, backgrounds, financial situations, and/or the like to purchase real estate in a desired geographic location that the buyers would likely not qualify to purchase on their own in a co-buying arrangement. The system 100 further connects the buyers with real estate agents, financial institutions, and/or the like to facilitate the negotiation, purchase, and close of a real estate property.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things (“IoT”) device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

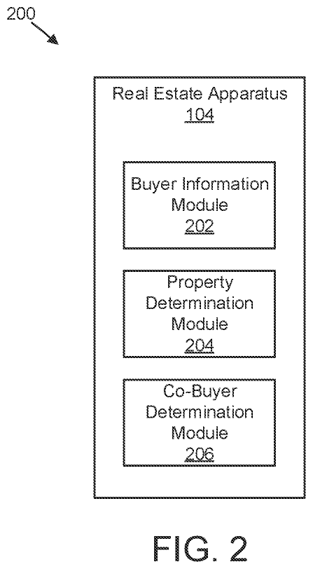

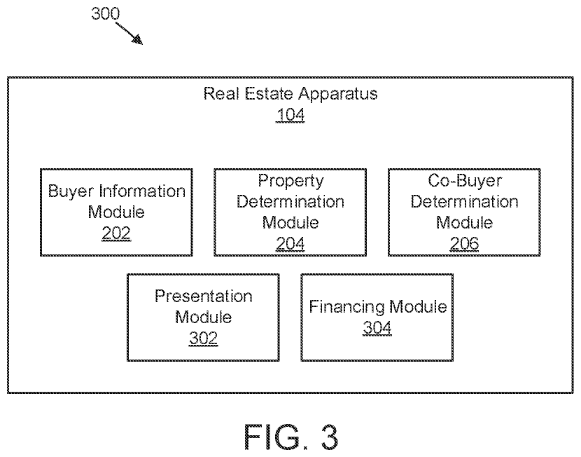

In one embodiment, the real estate apparatus 104 is configured to receive financial information associated with a first buyer and a geographic location of interest to the first buyer for purchasing real estate, determine one or more real estate properties for sale within the geographic location, and identify one or more potential co-buyers for a selected real estate property of the one or more real estate properties based on the received financial information for the first buyer and financial information associated with each of the one or more potential co-buyers. The real estate apparatus 104, including its various sub-modules, may be located on one or more information handling devices 102 in the system 100, one or more servers 108, one or more network devices, and/or the like. The real estate apparatus 104 is described in more detail below with reference to FIGS. 2 and 3.

The real estate apparatus 104, in one embodiment, improves upon conventional real estate purchasing methods by matching co-buyers to purchase properties within a geographic of interest to each of the co-buyers that a single buyer alone would not be able to purchase, e.g., due to financial limitations. Furthermore, the real estate apparatus 104 uses artificial intelligence/machine learning to find the best match for co-buyers based on various criteria including financial criteria, co-buyer match criteria (e.g., different characteristics that a buyer is looking for in a co-buyer), real estate property detail criteria (e.g., number of rooms, total square footage, number of bathrooms, or the like), and/or the like.

The subject matter disclosed herein, in one embodiment, is directed to crowdsourcing financially qualified co-buyers to purchase a home together by intelligently matching co-buyers for a home or a plurality of homes within a geographic area. Furthermore, in certain embodiments, the subject matter disclosed herein facilitates matching single buyers, investors, or the like with real estate properties for sale in a geographic area, including residential and/or commercial properties.

In various embodiments, the real estate apparatus 104 may be embodied as an application, e.g., a mobile application, a website, and/or a hardware appliance that can be installed or deployed on an information handling device 102, on a server 108, on a user's mobile device, on a display, or elsewhere on the data network 106. In certain embodiments, the real estate apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the real estate apparatus 104 may include a power interface, a wired and/or wireless network interface, a graphical interface that attaches to a display, and/or a semiconductor integrated circuit device as described below, configured to perform the functions described herein with regard to the real estate apparatus 104.

The real estate apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the real estate apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the real estate apparatus 104.

The semiconductor integrated circuit device or other hardware appliance of the real estate apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the real estate apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. In certain embodiments, the servers 108 may be a backend for a website or application that a buyer accesses to locate properties and potential co-buyers for a particular geographic location. In such an embodiment, the servers 108 may be cloud servers, e.g., AWS by Amazon®, or the like, and may store user account information, real estate/MLS information, financial/banking information, and/or the like.

FIG. 2 is a schematic block diagram illustrating one embodiment of an apparatus 200 for dynamically determining co-buyers for a property. In one embodiment, the apparatus 200 includes an embodiment of a real estate apparatus 104. The real estate apparatus 104, in certain embodiments, includes one or more of a buyer information module 202, a property determination module 204, and a co-buyer determination module 206, which are described in more detail below.

The buyer information module 202, in one embodiment, is configured to receive financial information associated with a first buyer. The first buyer may be a buyer looking for a real estate property to purchase such as a single family home, a condo, an apartment, raw land, commercial properties, and/or the like. The financial information for that is received from the first buyer may include a gross monthly income, an amount available for a down payment, a credit score, a debt level (e.g., an amount of credit card debt, mortgages, and/or the like), savings/checking/retirement account balances, and/or the like.

The buyer information module 202 may further receive a geographic location of interest to the first buyer for purchasing real estate. The geographic location may comprise a state, a county, a parish, a community, a city, a town, a neighborhood, a street, a block, a user-defined geographic area (e.g., a geographic area on a map that the user defines), and/or the like. The first buyer may provide the financial and/or location information via an interface such as a website, a mobile application, a desktop application, a command line interface, an application programming interface (“API”), and/or the like.

In one embodiment, the buyer information module 202 dynamically determines the geographic location of interest for the first buyer by monitoring, recording, and/or analyzing the geographic areas where the first buyer has previously searched for real estate properties (e.g., using an online service such as Zillow®, or the like). In such an embodiment, the buyer information module 202 determines real estate properties that the user has favorited, liked, starred, bookmarked, or otherwise saved for later reference (e.g., in an online service such as Zillow®, on a social media network, or other real estate website or application).

The buyer information module 202 may further track other details about the real estate properties that the first buyer has viewed/favorited such as the real estate property type (e.g., single family home, condo, apartment, or the like), the size/square footage of the real estate property, the number of bedrooms/bathrooms, the color of the real estate property, the finishes in the real estate property, and/or the like. In this manner, the buyer information module 202 may automatically filter a real estate listing to properties that the first buyer has previously shown interest in, or fill-in or enter certain real estate information or criteria for the first buyer for the first buyer's search of a real estate property.

The property determination module 204, in one embodiment, is configured to determine one or more real estate properties for sale within the geographic location. The property determination module 204, for instance, may search a multiple listing service (“MLS”) database, or other accessible database, that includes real estate properties that are for sale within the defined geographic area/location.

In certain embodiments, the determined one or more real estate properties for the geographic location includes fractional shares of real estate properties that are for sale. For instance, a seller may offer a half share of a home or a quarter share of an apartment for sale, or the like. Similarly, the first buyer may be searching for co-buyers that want to enter into unequal ownership shares, including unequal monthly payments.

The co-buyer determination module 206, in one embodiment, is configured to identify one or more potential co-buyers for a selected real estate property of the one or more real estate properties based on the received financial information for the first buyer and financial information associated with each of the one or more potential co-buyers. In such an embodiment, the co-buyer determination module 206 uses financial information provided for each of the potential co-buyers and their provided locations of interest to determine whether the potential co-buyers may be a good match for the selected real estate property based on the first buyer's financial information and specified match criteria (described below).

For instance, the co-buyer determination module 206 may receive a selection of a real estate property from the first buyer, e.g., from a list of the available properties or from a map display, and in response to the selection the co-buyer determination module 206 may determine other buyers who are interested in a co-buying partnership for that particular property, for the area in which the property is located, or the like, that qualify financially for the property (together with the first buyer), and that meet certain match criteria that the first buyer has specified for the potential co-buyers.

As used herein, the term co-buyer may refer to any additional borrower whose name appears on loan documents and whose income and credit history are used to qualify for the loan. Under this arrangement, all parties involved have an obligation to repay the loan. For mortgages, the names of applicable co-buyers/co-borrowers also appear on the property's title. In certain embodiments, some co-buyers may not appear on the title or mortgage. In such an embodiment, the subject matter disclosed herein allows for co-ownership models that record a co-buyer's interest in the property other than title and mortgage, such as a separate contract, a lien (which may be recorded on the title), and/or the like. A co-borrower may be used to help an individual obtain a loan that they were not otherwise able to qualify for on their own.

In certain embodiments, the first buyer is looking for one or more co-buyers to occupy the property with the first buyer. In such an embodiment, the buyer information module 202 may receive match criteria for potential co-buyers such as whether or not co-buyers are allowed to smoke/drink/party, whether or not pets are allowed, whether or not children are allowed, the age(s) of the potential co-buyer, the gender(s) of the potential co-buyer, and/or the like.

Based on the match criteria, the co-buyer determination module 206 identifies the one or more potential co-buyers based on the match criteria for each of the one or more potential co-buyers that the first buyer provides, in addition to the financial information for the potential co-buyers.

The co-buyer determination module 206, in response to the first buyer selecting a real estate property, e.g., from a list of real estate properties or from a map view of the real estate properties, dynamically determines and presents a list of one or more potential co-buyers for the selected real estate property. The co-buyer determination module 206, for example, may receive information about the first buyer, including financial information and match criteria, in response to the first buyer selecting a real estate property and may search, lookup, reference, or the like, in real-time, one or more potential co-buyers who satisfy the match criteria (or substantially all of the match criteria), who would qualify for a loan/mortgage together with the first buyer, and who are also interested in either the specific real estate property that is selected or in real estate properties within the geographic area of the selected real estate property.

In one embodiment, the co-buyer determination module 206 uses artificial intelligence/machine learning to rank each of the one or more potential co-buyers for the selected real estate property in terms of a best fit for the first buyer based on the financial information for each of the potential co-buyers and match criteria for the one or more potential co-buyers that the first buyer provides. Even though artificial intelligence/machine learning powered ranking is discussed in detail herein, other ranking methods may be used such as a weighted average ranking based on matching criteria between co-buyers, and/or the like.

As used herein, artificial intelligence may refer to the ability of a machine/computer to learn over time and simulate intelligent behavior. Furthermore, machine learning, as used herein, may refer to an application of artificial intelligence (“AI”) that provides systems the ability to automatically learn and improve from experience without being explicitly programmed. Machine learning focuses on the development of computer programs that can access data and use it learn for themselves.

The artificial intelligence/machine learning algorithms may comprise various types of machine learning algorithms such as supervised machine learning algorithms (e.g., nearest neighbor, naïve bayes, decision trees, linear regression, support vector machines, neural networks, etc.), unsupervised machine learning algorithms (e.g., k-means clustering, association rules, etc.), semi-supervised machine learning algorithms, and/or reinforcement machine learning algorithms (e.g., Q-learning, temporal difference, deep adversarial networks, etc.).

The co-buyer determination module 206 may train the artificial intelligence/machine learning algorithms using predefined or existing training data (e.g., from previous co-buyer purchases/arrangements) that may include co-buyer information such as co-buyer financial information (e.g., gross monthly income, debt level, credit score, amount for a down payment, and/or the like), different financial criteria (e.g., interest rates, down payment required for different loans/mortgages, and/or the like), different match criteria for a co-buyer (e.g., pets, smoking/non-smoking, drinking/non-drinking, pets/no pets, kids/no kids, and/or the like), match criteria for a real estate property (e.g., number of bedrooms, number of bathrooms, location, square footage, and/or the like), and/or the like.

Thus, the co-buyer determination module 206 may provide, as inputs to the artificial intelligence/machine learning, the first buyer's financial information and match criteria and the financial information and match criteria for the potential co-buyers to determine and rank the potential co-buyers based on the results of the artificial intelligence/machine learning.

In one embodiment, when the first buyer identifies a potential co-buyer for a property that he/she likes, the first buyer may want to see other potential real estate properties within the geographic location that the first buyer and the potential co-buyer may qualify for together. In such an embodiment, the co-buyer determination module 206 filters the list of real estate results for the geographic area to real estate properties that the first buyer and the selected potential co-buyer would be able to purchase together.

Furthermore, in one embodiment, the co-buyer determination module 206, in response to receiving a selection of one of the one or more potential co-buyers for the selected real estate property, facilitates communications between the first buyer and the selected co-buyer. The communications may include chatting or messaging through the interface, e.g., through the web site or application, sending emails, text messages, social media messages, and/or the like.

In this manner, the real estate apparatus 104 dynamically determines co-buyers for properties that are within a geographic area where the first buyer would like to purchase a property, but likely cannot qualify to get a loan or mortgage on the property alone. Furthermore, the real estate apparatus 104 matches the first buyer with co-buyers who meet certain criteria such as having an interest in properties within the same geographic location as the first buyer, having a financial situation that allows them to qualify for a loan with the first buyer, meeting certain personal or individual criteria that the first buyer establishes (e.g., smoking/non-smoking), and/or the like. The real estate apparatus 104 connects the first buyer with a plurality of available and interested co-buyers regardless of where the first buyer and the co-buyers currently reside to facilitate locating and purchasing a home within a defined geographic area.

In one embodiment, the subject matter disclosed herein provides for crowdsourcing real estate data (e.g., demand for specific locations, areas, and specific houses), popularity of geographic areas and properties (e.g., number of interested buyers, number of times the property is favorited, etc.), willingness of buyers to bid higher or lower for properties, how competitive the offer needs to be to win the bid, and/or to determine a separate artificial intelligence/machine learning method, or simpler methods, for determining the likely optimal or best offer price for purchasing and listing properties based on buyers search history, preference criteria, and financial information for the geographic area.

FIG. 3 is a schematic block diagram illustrating one embodiment of another apparatus 300 for dynamically determining co-buyers for a property. In one embodiment, the apparatus 300 includes an embodiment of a real estate apparatus 104. The real estate apparatus 104, in certain embodiments, includes one or more of a buyer information module 202, a property determination module 204, and a co-buyer determination module 206, which may be substantially similar to the buyer information module 202, the property determination module 204, and the co-buyer determination module 206 described above with reference to FIG. 2. In further embodiments, the real estate apparatus 104 includes one or more of a presentation module 302 and a financing module 304, which are described in more detail below.

The presentation module 302, in one embodiment, is configured to present the one or more real estate properties that are for sale within the geographic location in one of a list and a map. The presentation module 302, in response to the property determination module 204 determining the real estate properties that are for sale within the provided geographic location, generates a list of the real estate properties and/or generates a map of the geographic area with the locations of the real-estate properties highlighted on the map.

The list may be sorted by various criteria such as purchase price, square footage, distance from a point of interest, number of bedrooms, number of bathrooms, and/or the like. The list may also be sorted by the amount of the first buyer's portion of an estimated monthly payment, by the estimated down payment or credit score required to purchase the property, and/or the like. The list may also be filtered by various criteria such as a maximum monthly payment, a maximum down payment, a particular co-buyer(s), and/or the like.

The presentation module 302, in one embodiment, may present markers, tags, pins, or the like on the map of the geographic area that indicate where the real estate properties are located. The map and the list may be tied together so that when the first buyer selects a property in the list, the property is highlighted or otherwise indicated on the map. In certain embodiments, either on the list and/or on the map, the presentation module 302 visually highlights real estate properties within the geographic location that match different levels of the first buyer's financial information, home criteria, and co-buyer criteria. For instance, the presentation module 302 may use a green color to indicate real estate properties that meet 90%+ of the first buyer's criteria, a yellow color to indicate real estate properties that meet 40-89% of the first buyer's criteria, and a red color to indicate real estate properties that meet less than 40% of the first buyer's criteria.

In certain embodiments, the first buyer may change criteria on the fly (e.g., change the geographic location, change home requirements, change co-buyer criteria, update financial information, and/or the like), and, in response to the changed criteria, the property determination module 204 may determine real estate properties within the geographic area that matches the criteria and the presentation module 302 may dynamically update the listing/mapping of real estate properties within the geographic area.

The financing module 304, in one embodiment, is configured to determine one or more financial institutions that can facilitate purchasing the selected real estate property based on the financial information for the first buyer and the financial information for the one or more potential co-buyers. The financing module 304, in certain embodiments, takes the first buyer's financial information and the financial information for one or more potential co-buyers and checks with various banks or other financial institutions to determine interest rates, down payment requirements, different loan types and amounts, and/or the like for the first buyer and the potential co-buyers.

The financing module 304, in one embodiment, is configured to present a financial dashboard for pre-qualifying buyers for a potential co-purchase arrangement. The dashboard may be used to collect financial information from a buyer such as a maximum down payment, a maximum monthly payment, a credit score, and a debt-to-income ratio. The financial module 304 may estimate and present the buyer's gross monthly income in response to the buyer entering the maximum monthly payment. The financial module 304 may estimate and present the buyer's total available savings based on the entered maximum down payment. In certain embodiments, the financial module 304 verifies that the buyer has a credit score by prompting the buyer to confirm where the credit score was calculated, e.g., which company the credit score came from. In this manner, instead of requiring a pre-qualification prior to allowing the buyer to search for real estate properties, the buyer can immediately begin searching for properties using a minimum of two pieces of information—maximum down payment and maximum monthly payment—and then encourage them to update the credit score and debt-to-income information.

The co-buyer determination module 206 may further determine a best match co-buyer for the first buyer based on the financial/loan information that the financing module 304 determines. The financing module 304, in certain embodiments, facilitates the loan application process for the first buyer and a selected co-buyer by pre-populating application forms with the first buyer's and the selected co-buyer's information, pulling credit scores for the first buyer and the selected co-buyer, providing down payment information for the first buyer and the selected co-buyer, and/or the like.

In certain embodiments, the financing module 304 pulls current and historical interest rate data, historical down payment data, and/or the like from various banks or other financial institutions and uses artificial intelligence/machine learning to determine, predict, estimate, forecast, and/or the like the best time to apply for a mortgage based on the first buyer's and the co-buyer's financial information, the interest rate data, and the down payment data, including which banks may have the best interest rates, the lowest down payments, the lowest debt-to-income ratios, and/or the like.

The financing module 304 may further identify or estimate the monthly payment and each buyer's portion of the monthly payment (based on the rates and other financial information that the machine learning determines), may estimate the down payment and each buyer's portion of the down payment, may estimate taxes and insurance, and may estimate other costs associated with purchasing a selected real estate property (e.g., cost of living expenses for the selected geographic area including food, gas, transportation, utilities, and/or the like). The presentation module 302 may display each buyer's estimated portion of the expenses on the listing and/or the map of real estate properties. The estimates may be dynamically adjusted based on how many potential co-buyers are selected, in response to different potential co-buyer(s) being selected, in response to new or updated financial information, and/or the like.

In one embodiment, the financing module 304 determines one or more real estate agents that can assist the first buyer and the co-buyers in negotiations for purchasing the selected real estate property. The financing module 304 may determine real estate agents that have high reviews, low fees/commissions, high ethical ratings, high success/close ratings, and/or the like.

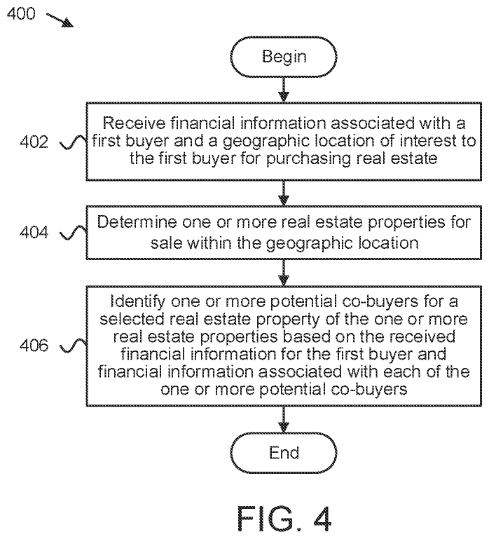

FIG. 4 is a schematic flow chart diagram illustrating one embodiment of a method 400 for dynamically determining co-buyers for a property. In one embodiment, the method 400 begins and receives 402 financial information associated with a first buyer and a geographic location of interest to the first buyer for purchasing real estate. In certain embodiments, the method 400 determines 404 one or more real estate properties for sale within the geographic location. In certain embodiments, the method 400 identifies 406 one or more potential co-buyers for a selected real estate property of the one or more real estate properties based on the received financial information for the first buyer and financial information associated with each of the one or more potential co-buyers, and the method 400 ends.

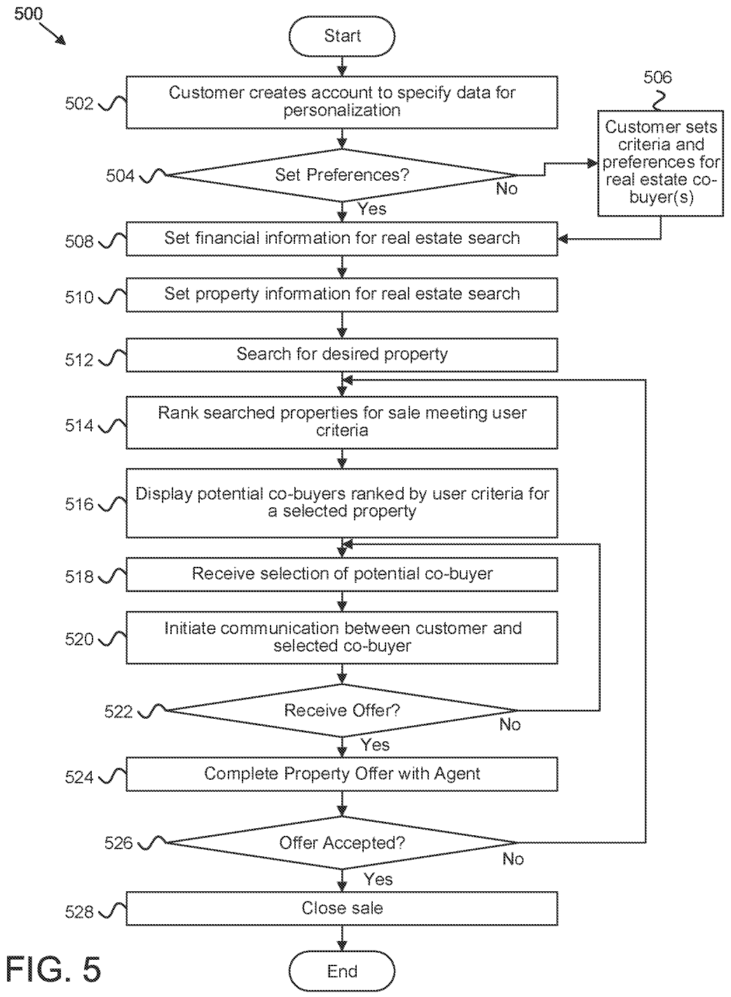

FIG. 5 is a schematic flow chart diagram illustrating one embodiment of a method 500 for dynamically determining co-buyers for a property. In one embodiment, the method 500 begins and creates 502 an account for a customer/first buyer based on information that the first buyer provides, including personal identification information, credential (e.g., username/password) information, financial information (e.g., gross monthly income, debt level, credit score, savings/checking account balances, etc.) and/or the like.

In further embodiments, the method 500 determines 504 whether the first buyer has set criteria/preferences. If not, the method 500 receives and sets 506 real estate property preferences (e.g., square footage, number of bedrooms, etc.), co-buyer preferences (e.g., non-smoker, no pets, etc.), and/or the like. The method 500, in one embodiment, receives and sets 508 financial information criteria for a real estate search including maximum monthly payment that the first buyer wants to pay, maximum down payment, credit score information, and/or the like.

In some embodiments, the method 500 receives and sets 510 property information for the real estate search including a geographic area such as a town, neighborhood, city, county, a user-defined area, or the like. In one embodiment, the method 500 searches 512 for real estate properties within the specified geographic location and ranks 514 the properties according to an amount in which the real estate properties meet the first buyer's specified criteria.

In one embodiment, the method 500 receives a selection of a real estate property and displays 516, in substantially real-time, a list of potential co-buyers for the real estate property that are ranked according to the first buyer's criteria (which may be determined according to the results of the machine learning). In certain embodiments, the method 500 receives 518 a selection of one or more co-buyers for the selected real estate property.

The method 500, in one embodiment, initiates 520 and facilitates communications between the first buyer and one or more selected co-buyers. Communications between the first buyer and the one or more selected co-buyers may continue offline, and if a decision 522 is made to not make an offer with the selected co-buyers, the method 500 returns to selection 518 of other co-buyers.

Otherwise, the method 500 places 524 the first buyer and the co-buyers in contact with an agent to help complete the offer for the real estate purchase. If the offer is not accepted 526, the method 500 returns to searching 514 real estate properties to purchase. Otherwise, the method 500 facilitates 528 closing the sale (by pre-populating or automatically filling out loan application and other real estate purchase forms) and taking possession of the property, and the method 500 ends. In certain embodiments, the buyer information module 202, the property determination module 204, the co-buyer determination module 206, the presentation module 302, and the financing module 304 perform the various steps of the method 500.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor;
a memory that stores code executable by the processor to:
receive financial information associated with a first buyer and a geographic location of interest to the first buyer for purchasing real estate;
determine one or more real estate properties for sale within the geographic location; and
identify one or more potential co-buyers for a selected real estate property of the one or more real estate properties based on the received financial information for the first buyer and financial information associated with each of the one or more potential co-buyers.

2. The apparatus of claim 1, wherein the code is executable by the processor to identify the one or more potential co-buyers based on match criteria for each of the one or more potential co-buyers that the first buyer provides.

3. The apparatus of claim 1, wherein the code is executable by the processor to:
present the one or more real estate properties that are for sale within the geographic location in one of a list and a map;
receive a selection of a presented real estate property from the first buyer; and
present a list of the one or more potential co-buyers for the selected real estate property.

4. The apparatus of claim 3, wherein the code is executable by the processor to:
receive a selection of one of the one or more potential co-buyers for the selected real estate property; and
facilitate communications between the first buyer and the selected co-buyer.

5. The apparatus of claim 1, wherein the code is executable by the processor to determine one or more financial institutions that can facilitate purchasing the selected real estate property based on the financial information for the first buyer and the financial information for the one or more potential co-buyers.

6. The apparatus of claim 5, wherein the code is executable by the processor to pre-populate one or more fields in an application for financing at a selected one of the determined one or more financial institutions with personal and financial information for the first buyer and a selected one of the one or more potential co-buyers.

7. The apparatus of claim 1, wherein the code is executable by the processor to use machine learning to rank each of the one or more potential co-buyers for the selected real estate property based on the financial information for each of the potential co-buyers and match criteria for the one or more potential co-buyers that the first buyer provides.

8. The apparatus of claim 1, wherein the code is executable by the processor to filter the determined real estate properties that are for sale within the geographic location by a selected potential co-buyer.

9. The apparatus of claim 1, wherein the code is executable by the processor to use machine learning to estimate the first buyer's portion of a monthly payment and a total monthly cost of the selected real estate property based on each of the potential co-buyers.

10. The apparatus of claim 1, wherein the code is executable by the processor to visually highlight real estate properties within the geographic location that match different levels of the first buyer's financial information, home criteria, and co-buyer criteria.

11. The apparatus of claim 1, wherein the code is executable by the processor to calculate an estimated portion of the down payment for the first buyer for the selected real estate property.

12. The apparatus of claim 1, wherein the determined one or more real estate properties for the geographic location comprises fractional shares of real estate properties that are for sale.

13. The apparatus of claim 1, wherein the financial information for the first buyer and the one or more co-buyers comprises a gross monthly income, an amount available for a down payment, a credit score, and a debt level.

14. The apparatus of claim 1, wherein the code is executable by the processor to crowdsource real estate preference information from the first buyer and the one or more potential co-buyers to determine real-estate trends.

15. A method, comprising:
receiving, by a processor, financial information associated with a first buyer and a geographic location of interest to the first buyer for purchasing real estate;
determining one or more real estate properties for sale within the geographic location; and
identifying one or more potential co-buyers for a selected real estate property of the one or more real estate properties based on the received financial information for the first buyer and financial information associated with each of the one or more potential co-buyers.

16. The method of claim 15, further comprising identifying the one or more potential co-buyers based on match criteria for each of the one or more potential co-buyers that the first buyer provides.

17. The method of claim 15, further comprising:
presenting the one or more real estate properties that are for sale within the geographic location in one of a list and a map;
receiving a selection of a presented real estate property from the first buyer; and
presenting a list of the one or more potential co-buyers for the selected real estate property.

18. The method of claim 17, further comprising:
receiving a selection of one of the one or more potential co-buyers for the selected real estate property; and
facilitating communications between the first buyer and the selected co-buyer.

19. The method of claim 15, further comprising determining one or more financial institutions that can facilitate purchasing the selected real estate property based on the financial information for the first buyer and the financial information for the one or more potential co-buyers.

20. A program product comprising a computer readable storage medium and program code, the program code being configured to be executable by a processor to perform operations comprising:
receiving financial information associated with a first buyer and a geographic location of interest to the first buyer for purchasing real estate;
determining one or more real estate properties for sale within the geographic location; and
identifying one or more potential co-buyers for a selected real estate property of the one or more real estate properties based on the received financial information for the first buyer and financial information associated with each of the one or more potential co-buyers.
